(19) United States
(12) Patent Application Publication
(10) Pub. No.: US 2025/0209254 A1
(43) Pub. Date: Jun. 26, 2025

(54) Artificial Intelligence Projected View Interface

(71) Applicant: Cedric Daniel Thomas, Vancouver, WA (US)

(72) Inventor: Cedric Daniel Thomas, Vancouver, WA (US)

(21) Appl. No.: 18/395,290

(22) Filed: Dec. 22, 2023

(51) Int. Cl. G06F 40/109; G06F 3/01; G06T 13/80; G10L 15/08

(52) U.S. Cl. CPC G06F 40/109; G06F 3/012; G06F 3/013; G06T 13/80; G10L 15/08; G10L 2015/088

(57) ABSTRACT

The use of artificial intelligence to track someone's eye or eyes at any location of a screen, not head mounted (NHM), or projected visual plane to apply various visual effects and animations to and around the characters, texts, images, etc. they are viewing. This includes but is not limited to emotional animations, animated text, appearing and disappearing characters, background animations and visual effects related to words, characters, numbers, emotion animations and phrases being in view. The author can choose where these effects occur on a visual plane or around text, characters, emotional animations, numbers, etc. before, during or after the reader views the area around its location or choose to have the a.i. algorithm apply the effects for them. Effects can also be revealed through sounds the reader makes. The a.i. also tracks eye movements to be used as a pointer on a screen NHM or projected visual plane.

### BACKGROUND OF THE INVENTION

This invention uses artificial intelligence (a.i.) to follow or track the position of a human's focus on a screen or projected view plane to apply visuals effects to or around words, characters, numbers, emotion animations, etc. before, during or after they are being viewed. These effects should include but are not limited to glitter and sparkle effects, background animations, changing letterings, changing or bold words, emotion animations, hidden characters that appear when the area is viewed, etc. that occur preferably when the eye or eyes are focused around the area, they are embedded in the view plane. An example of invention would be a sun setting in the background of this text that occurs during, before or after you the reader reads this following word “sunset”. Another example would be the phrase “I'm hungry” in text turning into “I'M HUNGRY!!!!” only as the reader pans over the area where the phrase is located with their eye or eyes. The effects can stop once the readers focus leaves and vicinity that triggers the effects. The triggers can be embedded by the author of the communication, or the algorithm uses natural language processing (NLP) and machine learning (ML) to embed background or direct effects, animations, hidden words, changing characters etc. based on conventional human communication techniques. The full scope of the effects, animations and triggers also include words, phrases, characters, emotion animations and images not yet discovered or included in currently defined languages.

### PARTS

Parts include but are not limited to an artificial intelligence algorithm that is trained to work on the operating systems used by the author or reader of the communication to be displayed which can be embedded in the OS or used as an application or software addon. The a.i. would use any available hardware to recognize and track the focus of eyes on a view plane and affect objects in the area of the reader's focus or general view.

### Communication

The algorithm uses cameras and sensors or any tool for capturing visual and depth or distance information pertaining to the user's face and distance from the screen and including those not yet invented, to track the focus of the eye or eyes on a screen or projected view plane. This algorithm can be embedded into any device that it is compatible with or packaged as a software add on or application. The Artificial intelligence algorithm then shows hidden or not yet activated effects embedded by the author or the algorithm used by the author's device to the reader.

### Manufacturing Process

The Algorithm uses NLP and ML to track where the eyes are focused on a screen or projected view. One of the ways to accomplish this, but not limiting the manufacturing process to just this procedure, is to have an a.i. keep track of different groups of people's eyes while they read out loud. Then once it can attach the eyes' or eye's position to the position of words or characters being read on the screen it can then approximate the location of the eyes focus on a screen. The a.i. uses NLP to understand what the training readers are saying and ML to track the eyes position when these words are being said relative to the position of the words on to the screen. It can also use proximity sensors and other sensors, even those not yet invented, to gain insight on the distance and location of the user/reader's face to calculate a better approximation of the location of focus of the eyes or eye.

| | |
|---|---|
| Claims | Multiple claims made for patent |
| pg. 5 | application Ser. No. 18/338,268 |
| Abstract | Brief description of invention |
| pg. 6 | for searchable databases |
| FIG. 1 | A hypothetical image of a United States football |
| pg. 7 | ball play generated by an artificial intelligence |
| | algorithm after a command for the play is made |
| | by the offensive coordinator off the field. |
| FIG. 2 | A hypothetical image of a United States football |
| pg. 8 | ball play generated by an artificial intelligence |
| | algorithm showing a change made to the |
| | expected actions of “WR1” (Wide Receiver 1) |
| | after a command for the change to the play in |
| | FIG. 1 is made by the quarterback on the field. |

1: Using Artificial Intelligence to track the focus of the someone's eyes based on their head position and location relative to a screen not mounted on a head, projected view, camera/cameras and sensors where the screen is not mounted on a head.

2: Using an artificial intelligence algorithm to create visual effects and animations in or around text, characters, numbers, images etc. and/or showing emotion animations only when the eyes' or eye's focus is within some specific area on a screen or projected plain of view.

3: Using Natural Language Processing, machine learning, or any technique to train an algorithm not yet discovered to determine or embed visual effects in or around text or some specific area of view on a screen or projected view that would be acceptable based on widely accepted human communication.

4: Using artificial intelligence such as natural language processing and machine learning, or any technique to train an algorithm not yet discovered, to reveal effects to text or the area around the text in text messages within a mobile device such as a phone or tablet, etc. that's hidden until a user reads aloud certain text, characters or says specific words, phrases or sounds that trigger the embedded effect.

5: Using artificial intelligence such as natural language processing and machine learning, or any technique to train an algorithm not yet discovered, to reveal embedded or hidden effects to text, characters, images, numbers, etc or the area around them on screens whether head mounted or not and projected views.
